(19) United States
(12) Patent Application Publication
(10) Pub. No.: US 2025/0185619 A1
(43) Pub. Date: Jun. 12, 2025

(54) PROCESS OF OBTAINING CELLULOSE AND BENTONITE-BASED HYGIENIC PELLETS FOR ANIMALS AND PRODUCT OBTAINED

(71) Applicant: José Tadeu Dos Santos, Jaguariuna (BR)

(72) Inventor: José Tadeu Dos Santos, Jaguariuna (BR)

(21) Appl. No.: 18/617,048

(22) Filed: Mar. 26, 2024

(30) Foreign Application Priority Data
Dec. 7, 2023 (BR) BR 1020230257186

(51) Int. Cl. A01K 1/015

(52) U.S. Cl. CPC A01K 1/0155; A01K 1/0154

(57) ABSTRACT

The present invention refers to hygienic or sanitary pellets for animals that combine high power of absorption and great bindability capacity, enabling the formation of firm clumps and the neutralization of odors, given that the liquid animal excrement is not accumulated in the recipients where the product is placed. Accordingly, it comprises a mixture of bentonite in its formulation, in a proportion between 30 and 50% of the total volume of the formulation, and cellulose-based pellets, in a proportion between 50 and 70% of the total volume of the formulation.

### BRIEF DESCRIPTION

This present application for patent of invention of “PROCESS OF OBTAINING CELLULOSE AND BENTONITE-BASED HYGIENIC PELLETS FOR ANIMALS AND PRODUCT OBTAINED”, which refers to obtaining hygienic or sanitary pellets for animals comprising cellulose and bentonite-based pellets in its formulation, providing a product that combines two characteristics of major interest: high power of absorption and major clumping capacity, enabling the formation of firm clumps and the neutralization of odors, given that the liquid animal excrement is not accumulated in the recipients where the product is placed.

### FIELD OF APPLICATION

The present invention pertains to the sector of human needs, to the field of agriculture, more specifically, to the field of removal of animal excrement, because it refers to obtaining hygienic or sanitary pellets for animals comprising in its formulation a combination of cellulose and bentonite-based pellets.

### CONVINCING

The sanitary/hygienic pellets or litter for animals are an essential item for whoever cares for a household cat. Besides being highly useful and practical, this type of product is fundamental for the hygiene and well-being of animals, for it enables pets to cover up their feces and urine, generating a sensation similar to the one found in nature; and it facilitates the cleanliness of the ambient where animals live, given that it contributes to reduce odors from the excrement and facilitates the disposal thereof.

The use of the hygienic pellets, popularly known as “cat litter”, is quite straightforward: they are placed in litter boxes or litter trays, which are used instinctively by the animals, since they seek to eliminate odors that reveal their location, despite being protected in their homes, the household cats manage to reproduce this natural behavior with the help of the hygienic pellets, contributing to their well-being.

Therefore, the cat litter is the substrate utilized in the litter box, its function being to absorb the urine and cover up the feces, eliminating odors and keeping the site always dry, clean and pleasant for the animals. Therefore, so that it can fulfill its function, tutors must replace it with a certain frequency.

Since this product is frequently handled by tutors and used by cats, it must be easy to use for both. In this sense, a lesser density is interesting for tutors, given that the packets are large and the placement in a site with reduced size, as is the litter box, is hampered when the weight is rather great, and for the cats, who need to turn the pellets to bury their excrement. In this sense, since the present invention combines bentonite and cellulose pellets in its composition, it presents a reduced density, compared to products entirely bentonite-based products, that is, without the mixture with the pellets made of cellulose, diatomite, wood and silica.

Besides the reduced density, it is desirable that the pellets have a high power of absorption and major clumping capacity, enabling the formation of firm clumps and the neutralization of odors, accordingly, the liquids present in the animal excrement is not accumulated in the recipients where the product is placed, which also contributes to stem the proliferation of micro-organisms.

In light of the foregoing, it is noted that the present invention contributes to solving problems pending in the technical field, by providing a product that combines the excellent absorption capacity of the cellulose with the high clumping capacity of the bentonite, providing a product that associates these two fundamental characteristics in one efficient product.

### BACKGROUND OF THE INVENTION

Today, several options of sanitary/hygienic pellets or litter for animals are known. This type of product significantly facilitates the hygiene of the animal, in addition to cleaning the site by the tutors. Pellets are present on the market made of clay, wood, silica, wheat residue, sugarcane bagasse, diatomite, among others.

Each one of these products has its own peculiarities. For example, pellets made solely of cellulose; ordinary sand; clay; wood pellets; wheat residues; sugarcane bagasse and diatomite present high density; handling difficulty; high weight of the packages, albeit with the same volume of material; big dirt trail and they are not good binders, hindering the formation of clumps. Products made entirely of bentonite are good binders, yet do not have good absorption, which enables the accumulation of liquid excrement in the recipients, generating the release of odors and proliferation of micro-organisms; additionally, these products have a production process that is more aggressive to the environment, as it requires the extraction of large quantities of minerals and cannot be discarded in toilet bowls. The present invention was devised with a view to combining the good binding capacity of bentonite with the good absorption capacity of cellulose.

The prior art BR102018072830A2, entitled “Process of obtaining hygienic/sanitary cellulose pellets for animal use and product thus obtained”, refers to a process of obtaining of hygienic/sanitary pellets made of virgin cellulose pulp and/or recovered from primary sludges from cellulose and paper factories, to be used in the breeding of cats and in captivity as well as in the breeding of small rodents in household environments or in commercial creations for various uses such as, for example, guinea pigs. In this sense, the process comprises the following steps:
1. Obtaining the cellulose pulp recovered from the primary sludge;
1a. Processing of the virgin cellulose pulp in hydra pulper;
1. Processing of the cellulose pulp in dewatering/extruder screw;
2a. Bleaching;
2. Treatment with biocide;
3. Classification;
4. Drying;
5. Functional coating of the pellets;
6. Application of binding agents; and
7. Packaging.

It is important to point out that part of the process described in the prior art mentioned is employed in the present invention, since both have a same inventor, given that it refers to hygienic or sanitary pellets for animals comprising in its formulation: bentonite, in a proportion between 30 to 50% of the total volume of the formulation, and cellulose-based pellets, which is obtained according to part of the process described in document BR102018072830A2, in a proportion between 50 and 70% of the total volume of the formulation, in order to provide a product that combines two characteristics of major interest: high power of absorption and large clumping capacity, enabling the formation of firm clumps and the neutralization of odors, given that the liquid excrement of animals are not accumulated in the recipients where the product is placed.

The major technical advantage of the present invention in relation to the object of the prior art lies in providing a product that combines good bindability and absorption, differently to the clumps made up solely of cellulose, which despite having good absorbability, it does not have good bindability, not enabling the formation of firm clumps, which facilitate the sanitization of the recipient. Accordingly, the present invention represents an improvement of the prior art BR102018072830A2, not being anticipated thereby.

Prior art BR112016015161B1, entitled “Compositions of sanitary litter for animals, and manufacturing method thereof”, refers to the composition of a sanitary litter for animals that has a relatively low density (and thus lighter) and is partially composed of organic materials and, in the preferred embodiments, partially composed of inorganic materials, besides having other beneficial properties. Therefore, the document describes a composition comprising (i) a non-clumped particle, consisting essentially of organic material (for example, the organic material of the particle is not clumped or otherwise aggregated in a mass, or agglutinated with any other material), selected from the group consisting of particles of corncob, ground wheat, pellets of almond shell and pellets of pecan nut shell; and (ii) a coating in an outer surface of the particle, this coating comprises sodium bentonite. The prior art also describes an obtainment process comprising: (i) mixing non-clumped organic particles and a liquid to create wet organic particles; (ii) placing the wet organic particles into a blender; and (iii) adding bentonite sized in the range of 100 Mesh to 300 Mesh within the blender to coat the wet organic particles; and the addition of the bentonite is conducted for a period from 15 seconds to 2 minutes.

Although the document referred to previously describes the employment of bentonite for obtaining sanitary litter, it does not anticipate the present invention, since it does not describe a product comprising a mixture of cellulose-based pellets, the cellulose source of which is virgin cellulose pulp and/or recovered from primary sludges from cellulose and paper factories, which represents the transformation of a residue in raw material, and bentonite-based pellets, present in a proportion lower than generally employed in this type of product, which represents lesser environmental impact of the production of the pellets claimed.

The prior art BR112020017470A2, entitled “Non-clay-based clumping sanitary litter for pets and methods of manufacturing and use of these sanitary litter for pets”, refers to non-clay-based clumping sanitary litter for pets, which may include mixing a material natural; compress the mixed natural material for forming pellets; grind the pellets to form pellets; sieve the pellets to obtain a pre-determined size range; and apply functional additives to the sized pellets. The functional additives present in the product may include a binding agent, mineral oil and a surfactant, besides, additionally, a fragrance oil. The binding agent may be guar gum, and the surfactant may be a polysorbate. The material natural present may be one or more from among recycled paper, corrugated cardboard and sawdust. In another aspect, the non-clay-based clumping sanitary litter for pets contains pellets of natural compacted material surrounded by a coating containing a binding agent, a mineral oil that adheres the binding agent to the pellets and a surfactant.

The prior art BR102016026058A2, entitled “Pellets or coconut dust for coating and covering stalls, terrariums and pet sanitary litter” refers to pellets or coconut dust for coating and covering bays, terrariums and pet sanitary litter, obtained from an industrial technique for obtaining a coconut-derived material, coined from pellets or coconut dust, which, according to the technical specifications is used in bedding for accommodating horses, cattle, pigs, sheep, reptiles, poultry and pets. Given that the prior art comprises a different raw material to the present invention and that it does not suggest a composition made up of cellulose and bentonite-based pellets.

The prior art BR0106609A, entitled “Powder product for sanitizing and binding sanitary litter and method of composition and maintenance of a bedding of sanitary litter for cats”, refers to a product composed of a load of clay, bentonite, used in a suitable amount for maintaining the product in powder form, pursuant to the characteristics of the clay and which incorporated product destined for sanitizing per se; and the method comprising composition stage of the bed composed of the mixture of the litter and product and the maintenance; and after the cat has defecated and/or urinated in the bed and the sanitizing and binding powder product has bound the feces and/or urine and the litter, forming clumps composed of the product, litter and feces and/or urine, maintenance stage comprised by gathering up the clumps from between the remainder of the means constituting the bedding and disposal of the clumps.

The prior art BR112020017470A2, entitled “Formulation for obtaining an odor-eliminating product, for mixing in sanitary litter”, refers to a formulation composed of benzalkonium chloride, extra-fine neutral alcohol, an odor blocker and Koralone®, homogenized in suitable volume percentages for obtaining an odor-blocking product, which is added to the sanitary litter used for the urine of household cats. There, the prior art does not anticipate the subject matter disclosed in the present invention.

### OBJECTIVE OF THE INVENTION

The objective of the present invention is to provide a hygienic or sanitary pellets for animals comprising in its formulation bentonite and cellulose-based pellets, providing a product that combines high power of absorption and great bindability capacity, enabling the formation of firm clumps and the neutralization of odors originating from the animal excrement.

### THE INVENTION

The present invention refers to hygienic or sanitary pellets for animals comprising in its formulation bentonite, in a proportion between 30 and 50% of the total volume of the formulation, and cellulose-based pellets, in a proportion between 50 and 70% of the total volume of the formulation, providing a product that combines two characteristics of major interest: high power of absorption and great bindability capacity, enabling the formation of firm clumps and the neutralization of odors, given that the liquid excrement of animals is not accumulated in the recipients where the product is placed.

### ADVANTAGES OF THE INVENTION

The main advantages of the present invention are:
Provide a product that combines high absorption power and great bindability capacity;
Provide a product of reduced density, that facilitates distribution logistics thereof, its placement, by the tutors, in the recipients and use by the pets;
Provide a product whose obtainment process has lesser environmental impact, since it combines pellets whose raw material is recovered from industrial waste and a clay mineral, the latter in lesser quantity, in contrast with the main competing products.

### DESCRIPTION OF THE DRAWINGS

In order to facilitate the understanding of the present invention, references will be made to the figure described ahead:

FIG. 1: Flowchart of the process of obtaining the bentonite-based hygienic pellets, present in the invention in a proportion between 30 and 50% of the total volume of the formulation, and of cellulose-based pellets, present in the invention in a proportion between 50 and 70% of the total volume of the formulation.

### DETAILED DESCRIPTION OF THE INVENTION

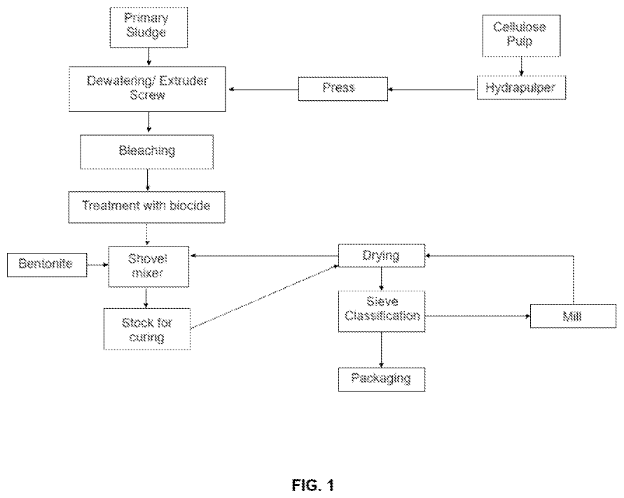

The process of obtaining hygienic pellets for animals based on bentonite and cellulose (FIG. 1) begins with the preparation of the primary sludge and of the cellulose pulp, as partially described in the process claimed in document BR102018072830A2, accordingly, this preparation comprises the following steps:
1. Obtaining the cellulose pulp recovered from primary sludge:
The cellulose pulp is recovered from primary sludge, a material withdrawn from rotary filters, dewatering screens, presses or other devices, before entering into the effluent treatment system, as a means to reduce the organic load in the treatment of industrial effluents of the cellulose pulp and/or paper production units;
the material obtained in this step presents the form of mantle or particles and high moisture content (between 90 and 99%). The material in question, when dry, contains between 70% and 99% of fibers and between 1% and 30% of other components, such as kaolin, calcium carbonate, titanium dioxide among other potential components;
2. Processing of the virgin cellulose pulp in a hydra pulper:
The virgin cellulose pulp must first be processed in a hydra pulper, presenting a consistency varying between 0.1% and 4%; afterwards, it is directed towards the press and, then to the dewatering/extruder screw for the production of cellulose pellets;
3. Processing of the hydra pulper and of the cellulose recovered from primary sludge in a dewatering/extruder screw:
Viewing the formation of cellulose pulp pellets, the primary sludge and the hydra pulper are processed in a dewatering/extruder screw, the rotation between 2 and 30 rpm. The rotation movement of the screw promotes the winding of the fibrous material leading to the formation of pellets and reduction of the moisture content to 60% to 90%;
4. Bleaching:
This is an optional step, where hydrogen peroxide and/or sodium hypochlorite are added in loads that vary from 1 to 20 kg/t of pellet;
Additionally, before adding hydrogen peroxide, sodium hydroxide can be added in an amount of 1 to 20 kg/t;
This step can be carried out in rotary mixing equipment of the concrete mixer or rotary cylinder type. The addition of the chemical agents is carried out by sprinkling solutions with known concentrations over the pellets;
5. Treatment with biocide:
After the formation of the pellets or after the optional step of bleaching, the pellets are treated with biocides with a view to eliminating potential colonies of undesirable micro-organisms. Accordingly, the pellets are processed in a rotary mixer (batch) or rotary cylinder (continuous), the biocide agents being applied by sprinkling on the mass of pellets of cellulose in proportions varying from 50 to 5000ppm of biocide considering the mass of cellulose pellets;
Among the main biocide agents that can be used in this step of the process are: quaternary ammonium salts, halogenated styrenes, thiocyanates, carbamates and modified phenols (sodium benzoate, among others).

After preparing the primary sludge and the cellulose pulp, the cellulose recovered of the primary sludge and the hydra pulper are added, in a proportion between 50 and 70% of the total volume of the formulation, to the shovel mixer, jointly with the bentonite, in a proportion between 30 and 50%.

After the mixture, a stock is made for curing. Thereafter, drying is carried out at ambient temperature for a period of 7 to 15 days with periodic turning every 12 or 24 hours; or in static fluidized bed driers, or rotary driers/ovens; in this equipment, the operating temperature varies from 35 to 250° C., for a variable period of time, with a view to obtaining pellets having a moisture content between 3% and 7%.

After drying, classification is carried out in a manual, vibratory or rotary sieve, with a Mesh 4/20, the material being withdrawn between sieves 4 and 20 destined for application as hygienic/sanitary pellets for use with pets (cats). In some cases, it is also possible to use sieves with an opening of 6/60 Mesh. If the mixture is not of a suitable size, it undergoes grinding, is dried again, returning to the mixer where the process is resumed. After classification, the pellets are wrapped, the product being ready for use.

Accordingly, the composition of the bentonite and cellulose flour-based pellets comprises:
Bentonite, in a proportion between 30 and 50% of the total volume of the formulation; and
Cellulose-based pellets, comprised of primary sludge and hydra pulper, in a proportion between 50 and 70% of the total volume of the formulation.

1. BENTONITE AND CELLULOSE-BASED HYGIENIC PELLETS, comprising a mixture of bentonite, in a proportion between 30 and 50% of the total volume of the formulation; and of cellulose-based pellets, made from primary sludge and hydra pulper, in a proportion between 50 and 70% of the total volume of the formulation.

2. PROCESS OF OBTAINING BENTONITE AND CELLULOSE-BASED HYGIENIC PELLETS, according to claim 1, wherein the primary sludge being comprised from 70% to 99% of fibers and, between 1% and 30% of other components, such as kaolin, calcium carbonate, titanium dioxide, with moisture content between 90 and 99%.

3. PROCESS OF OBTAINING BENTONITE AND CELLULOSE-BASED HYGIENIC PELLETS, according to claim 1, wherein it begins with the preparation of the primary sludge and cellulose pulp, from the following steps: obtaining the cellulose pulp recovered from the primary sludge; processing the virgin cellulose pulp in a hydra pulper, then pressing;
afterwards, the hydra pulper is and the cellulose pulp recovered from the primary sludge are directed towards the dewatering/extruder screw, with rotation between 2 and 30 rpm, until reduction of the moisture content for 60% to 90%, with winding of the fibrous material and formation of pellets; in an optional step, the cellulose pellets obtained are bleached with hydrogen peroxide and/or sodium hypochlorite in loads of 1 to 20 kg/t of pellets, additionally, before adding hydrogen peroxide, sodium hydroxide may be added in an amount of 1 to 20 kg/t; after the formation of the pellets or after the optional step of bleaching, the pellets are treated with biocides, in a rotary mixer (batch) or rotary cylinder (continuous), the biocide agents being applied by sprinkling over the mass of cellulose pellets in proportions of 50 to 5000ppm of biocide considering the mass of cellulose pellets, the biocide agent being selected from among: quaternary ammonium salts, halogenated styrenes, thiocyanates, carbamates and modified phenols; after preparing the primary sludge and the hydra pulper, both are added, in a proportion between 50 and 70% of the total volume of the formulation, to the shovel mixer, jointly with the bentonite, in a proportion between 30 and 50%; after the mixture, a stock for curing is made and, next, drying is carried out at ambient temperature for a period of 7 to 15 days with periodic turning every 12 or 24 hours, or in fluidized bed static driers, or rotary driers/ovens, with an operating temperature of 35 to 250° C., for a sufficient time to obtain pellets with moisture content between 3% and 7%; after drying, classification is carried out in a manual, vibratory or rotary sieve, with a Mesh 4/20, the material being withheld between sieves 4 and 20, alternatively, sieves with a 6/60 Mesh opening can be used; if the mixture is not at the suitable size, it undergoes grinding, is again dried, returning to the mixer where the process is resumed; after classification, the pellets are wrapped, the product being ready for use.
